(19) United States
(12) Patent Application Publication
(10) Pub. No.: US 2024/0031163 A1
(43) Pub. Date: Jan. 25, 2024

(54) CLOUD-BASED SECURED COMPONENT VERIFICATION SYSTEM AND METHOD

(71) Applicant: Dell Products, L.P., Round Rock, TX (US)

(72) Inventors: Antonio L. Fontes, Northbridge, MA (US); Massarrah N. Tannous, Cambridge, MA (US); Wai Yim, Merrimack, NH (US); Jason Matthew Young, Round Rock, TX (US); Azzam N. Tannous, Cambridge, MA (US); Jean Pierre, Cambridge, MA (US)

(73) Assignee: Dell Products, L.P., Round Rock, TX (US)

(21) Appl. No.: 17/814,081

(22) Filed: Jul. 21, 2022

(51) Int. Cl. H04L 9/32; H04L 9/08

(52) U.S. Cl. CPC H04L 9/3247; H04L 9/0825; H04L 9/0877

(57) ABSTRACT

Systems and methods for factory management of secured component verification in an Information Handling System (IHS) are described. In an embodiment, an IHS may include: a host processor; a security processor coupled to the host processor; and a memory coupled to the security processor, the memory having program instructions stored thereon that, upon execution by the host processor, cause the security processor to: obtain system information associated with the IHS from the security processor, sign the system information into a Secured Component Verification (SCV) certificate, issue the SCV to a cloud-based verification server. The verification server compares the system information with a stored golden copy of the system information, determines whether the comparison matches, and generates control information based upon the comparison. The host processor receives the control information from the cloud-based verification server, and controls the operation of the IHS based on the control information.

### BACKGROUND

As the value and use of information continues to increase, individuals and businesses seek additional ways to process and store it. One option available to users is an Information Handling System (IHS). An IHS generally processes, compiles, stores, and/or communicates information or data for business, personal, or other purposes thereby allowing users to take advantage of the value of the information. Because technology and information handling needs and requirements vary between different users or applications, IHSs may also vary regarding what information is handled, how the information is handled, how much information is processed, stored, or communicated, and how quickly and efficiently the information may be processed, stored, or communicated.

Cloud computing refers to a group of network elements providing services on demand, such as data storage and computing power, without directed active management by a user. Cloud computing relies on a sharing of resources to achieve coherence and economies of scale. Cloud computing can be provided as a service over the Internet, such as in the form of “Infrastructure as a Service” (laaS), “Platform as a Service” (PaaS), and/or “Software as a Service” (SaaS). A Platform as a Service (PaaS) provider allows a consumer to deploy onto the PaaS cloud infrastructure consumer resources created using program language, libraries, services and tools supported by the PaaS provider. The consumer does not manage or control the underlying cloud infrastructure, including the networks, servers, operating systems, or storage, but has control over the deployed applications. Platform as a Service (PaaS) providers offer a computing platform, typically including an operating system, programming language execution environment, database, and web server, and the consumer, or user, develops and runs software on the cloud platform, rather than obtaining and maintaining the underlying hardware and software layers.

### SUMMARY

A system and method for Systems and methods for factory management of secured component verification in an Information Handling System (IHS) are described. In an embodiment, an IHS may include: a host processor; a security processor coupled to the host processor; and a memory coupled to the security processor, the memory having program instructions stored thereon that, upon execution by the host processor, cause the security processor to: obtain system information associated with the IHS from the security processor, sign the system information into a Secured Component Verification (SCV) certificate, issue the SCV to a cloud-based verification server. The verification server compares the system information with a stored golden copy of the system information, determines whether the comparison matches, and generates control information based upon the comparison. The host processor receives the control information from the cloud-based verification server, and controls the operation of the IHS based on the control information.

According to another embodiment, a secured component verification method includes the steps of, by a customer HIS, obtaining system information associated with an Information Handling System (HIS) from a security processor, signing the system information into a Secured Component Verification (SCV) certificate, and issuing the SCV to a cloud-based verification server. The verification server compares the system information with a stored golden copy of the system information, determines whether the comparison matches, and generates control information based upon the comparison. The method further includes the steps of, by the customer HIS, receiving the control information from the cloud-based verification server, and controlling the operation of the IHS based on the control information.

According to yet another embodiment, a memory storage device has program instructions stored thereon that, upon execution by a customer Information Handling System (IHS), cause the customer IHS to obtain system information associated with the IHS from a security processor, sign the system information into a Secured Component Verification (SCV) certificate, and issue the SCV to a cloud-based verification server. The verification server compares the system information with a stored golden copy of the system information, determines whether the comparison matches, and generates control information based upon the comparison. The program instructions on the customer IHS receive the control information from the cloud-based verification server, and control the operation of the IHS based on the control information.

### BRIEF DESCRIPTION OF THE DRAWINGS

The present invention(s) is/are illustrated by way of example and is/are not limited by the accompanying figures, in which like references indicate similar elements. Elements in the figures are illustrated for simplicity and clarity and have not necessarily been drawn to scale.

FIG. 1 is a block diagram of an example IHS that may be configured to implement the secured component verification system according to one embodiment of the present disclosure.

FIG. 2 illustrates an example system according to one embodiment of the present disclosure.

FIG. 3 illustrates several components of the system according to one embodiment of the present disclosure.

FIG. 4 illustrates an example workflow diagram showing a component verification method according to one embodiment of the present disclosure.

FIGS. 5A and 5B illustrate how the cloud-based verification service indicates a healthy or degraded customer IHS due to Secured Component Verification (SCV) attestation.

### DETAILED DESCRIPTION

The present disclosure is described with reference to the attached figures. The figures are not drawn to scale, and they are provided merely to illustrate the disclosure. Several aspects of the disclosure are described below with reference to example applications for illustration. It should be understood that numerous specific details, relationships, and methods are set forth to provide an understanding of the disclosure. The present disclosure is not limited by the illustrated ordering of acts or events, as some acts may occur in different orders and/or concurrently with other acts or events. Furthermore, not all illustrated acts or events are required to implement a methodology in accordance with the present disclosure.

For purposes of this disclosure, an Information Handling System (IHS) may include any instrumentality or aggregate of instrumentalities operable to compute, calculate, determine, classify, process, transmit, receive, retrieve, originate, switch, store, display, communicate, manifest, detect, record, reproduce, handle, or utilize any form of information, intelligence, or data for business, scientific, control, or other purposes. For example, an IHS may be a personal computer (e.g., desktop or laptop), tablet computer, mobile device (e.g., Personal Digital Assistant (PDA) or smart phone), server (e.g., blade server or rack server), a network storage device, or any other suitable device and may vary in size, shape, performance, functionality, and price.

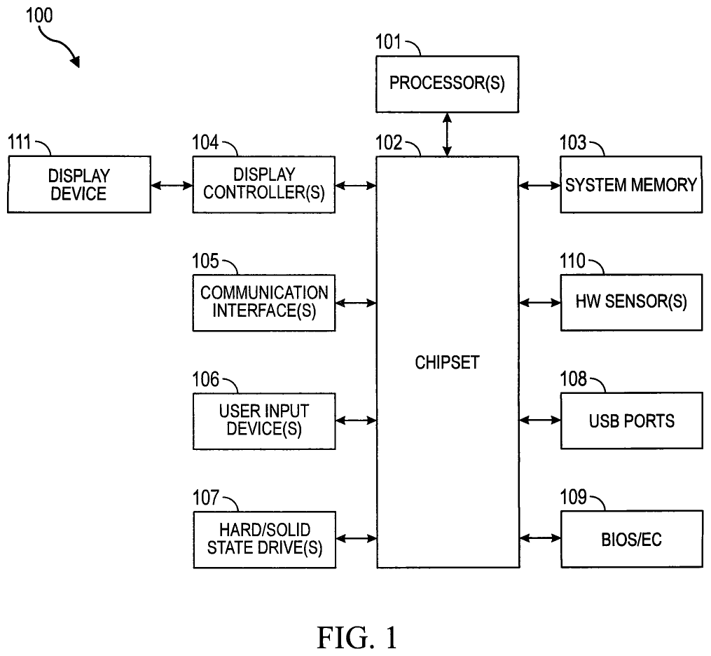

An IHS may include random access memory (RAM), one or more processing resources such as a central processing unit (CPU) or hardware or software control logic, ROM, and/or other types of nonvolatile memory. Additional components of an IHS may include one or more disk drives, one or more network ports for communicating with external devices as well as various input and output (I/O) devices, such as a keyboard, a mouse, touchscreen and/or a video display. An IHS may also include one or more buses operable to transmit communications between the various hardware components. A more detailed example of an IHS is described with respect to FIG. 1. It should be appreciated that although certain embodiments are discussed in the context of a personal computing device, other embodiments may utilize other types of IHSs.

Cybersecurity attacks take many shapes and forms. A supply chain attack is one among many attack types that has increased at an alarming rate of 78 percent (%) since 2018. A supply chain attack generally refers to a cyber-attack that targets one of many segments along an organization's supply chain. While some organizations may possess high value assets for any enterprise, they may be a prime target for supply chain attacks by state as well as non-state actors. Embodiments of the present disclosure address supply chain attacks by providing an end-to-end Cloud Based Secured Component Verification (SCV) system and method. The Cloud Based SCV (CBSCV) system and method may offer a comprehensive and cloud enabled approach to detect and remediate unauthorized tampering with products of an organization.

FIG. 1 is a block diagram of an example IHS 100 that may be configured to implement the secured component verification system according to one embodiment of the present disclosure. As depicted, IHS 100 includes processor 101. In various embodiments, IHS 100 may be a single-processor system, or a multi-processor system including two or more processors. Processor 101 may include any processor capable of executing program instructions, such as a PENTIUM series processor, or any general-purpose or embedded processors implementing any of a variety of Instruction Set Architectures (ISAs), such as an x86 ISA or a Reduced Instruction Set Computer (RISC) ISA (e.g., POWERPC, ARM, SPARC, MIPS, etc.).

IHS 100 includes chipset 102 coupled to processor 101. Chipset 102 may provide processor 101 with access to several resources. In some cases, chipset 102 may utilize a QuickPath Interconnect (QPI) bus to communicate with processor 101. Chipset 102 may also be coupled to communication interface(s) 105 to enable communications between IHS 100 and various wired and/or wireless networks, such as Ethernet, Wi-Fi, BT, cellular or mobile networks (e.g., code-division multiple access or “CDMA,” time-division multiple access or “TDMA,” Long-Term Evolution or “LTE,” etc.), satellite networks, or the like. In some cases, communication interface(s) 105 may be used to communicate with devices (e.g., BT speakers, microphones, headsets, etc.). Moreover, communication interface(s) 105 may be coupled to chipset 102 via a PCIe bus.

Chipset 102 may be coupled to display controller(s) 104, which may include one or more or graphics processor(s) (GPUs) on a graphics bus, such as an Accelerated Graphics Port (AGP) or Peripheral Component Interconnect Express (PC1e) bus. As shown, display controller(s) 104 provide video or display signals to display device 111. In other implementations, any number of display controllers or display devices may be used.

Display device 111 may include Liquid Crystal Display (LCD), Light Emitting Diode (LED), organic LED (OLED), or other thin film display technologies. Display device 111 may include a plurality of pixels arranged in a matrix, configured to display visual information, such as text, two-dimensional images, video, three- dimensional images, etc. In some cases, display device 111 may be provided as a single continuous display, rather than two discrete displays.

Chipset 102 may provide processor 101 and/or display controller(s) 104 with access to system memory 103. In various embodiments, system memory 103 may be implemented using any suitable memory technology, such as static RAM (SRAM), dynamic RAM (DRAM) or magnetic disks, or any nonvolatile/Flash-type memory, such as a solid-state drive (SSD) or the like. System memory 103 may store program instructions that, upon execution by processor 101, enable a collaboration mode for a touchpad coupled or integrated into IHS 100.

Chipset 102 may provide components of IHS 100 (e.g., processor(s) 101) with access to security processor 107. In various embodiments, security processor 107 may include a chip or core dedicated to providing encryption or other security operations to IHS 100. For example, security processor 107 may include a Trusted Platform Module (TPM) configured to securely store encryption keys and measurements that help verify the integrity of IHS 100. Additionally, or alternatively, a TPM-like architecture of security processor 107 may be integrated into processor(s) 101, BIOS/EC 109, a Baseband Management Controller (BMC), a storage controller, etc. Other examples of security processor(s) 107 include, but are not limited to: AMD's PLATFORM SECURITY PROCESSOR (PSP), MICROSOFTS's PLUTON, INTEL's CONVERGED SECURITY AND MANAGEMENT ENGINE (CSME), etc.

In some embodiments, security processor 107 may include registers, such as platform configuration registers (PCRs), and secure storage, such as a Non-Volatile Random-Access Memory (NVRAM). Security processor 107 may also include a cryptographic processor that supports various cryptographic capabilities. For example, a pre-boot process implemented by security processor 107 may utilize its cryptographic capabilities to calculate hash values that are based on software and/or firmware instructions utilized by certain core components of IHS 100. These calculated hash values may then be compared against reference hash values that were previously stored in a secure non-volatile memory, such as during factory provisioning of IHS 100. In this manner, security processor 107 may establish a root of trust that includes core components of IHS 100 validated as operating using instructions that originate from a trusted source.

Security processor 107 may include a superset of all regional cryptographic algorithms available and/or relevant at the time of IHS 100′s production. When IHS 100 is manufactured or serviced (e.g., by an Original Equipment Manufacturer or “OEM”), a factory or service facility IHS (equipped with a hardware security module or “HSM” configured to protect cryptographic keys, lifecycles, and infrastructures) selects one or more regional cryptographic algorithms among the superset of regional cryptographic algorithms to be activated in security processor 107, to the exclusion of all others.

In various implementations, only a factory IHS (i.e., an IHS at an OEM's factory that produces IHS 100 containing security processor 107) may be capable of changing a previous regional cryptographic algorithm selection (e.g., during servicing of IHS 100 following its manufacturing). Moreover, because all regional cryptographic algorithms available are included in security processor 107 out of the factory, subsequent changes to which regional cryptographic algorithms should be activated (e.g., in response to governmental policy changes, etc.) can take place independently of and/or without any changes to security processor 107′s firmware.

In some cases, regional cryptographic algorithm(s) may be selected, for example, based at least in part upon: a location of the IHSs factory (e.g., for customers who want US-built IHSs, with the US algorithm's activation occurring on US soil); a customer shipping destination (e.g., if a China-built IHS is shipped to Germany, the selection is aligned with EU requirements); and/or customer choice (i.e., the customer selects what algorithms they want used in their product). Certain embodiments may be implemented as part of a “personality module” outside of the security processor's firmware image and can also apply to whole or portions of the firmware image.

In some embodiments, chipset 102 may also provide access to one or more hard drives, solid state drives, optical drives, or other removable-media drives. In certain embodiments, chipset 102 may also provide access to one or more Universal Serial Bus (USB) ports 108, to which one or more peripheral devices may be coupled (e.g., internal or external webcams, microphones, speakers, etc.).

Chipset 102 may further provide access to one or more user input devices 106, for example, using a super I/O controller or the like. Examples of user input devices 106 include, but are not limited to, a keyboard, mouse, touchpad, stylus or active pen, totem, etc. Each of user input devices 106 may include a respective controller (e.g., a touchpad may have its own touchpad controller) that interfaces with chipset 102 through a wired or wireless connection (e.g., via communication interfaces(s) 105).

In certain embodiments, chipset 102 may also provide an interface for communications with one or more hardware (HW) sensors 110. HW sensors 110 may be disposed on or within the chassis of IHS 100, or otherwise coupled to IHS 100, and may include, but are not limited to: electric, magnetic, radio, optical (e.g., camera, webcam, etc.), infrared, thermal, force, pressure, acoustic, ultrasonic, proximity, position, deformation, bending, direction, movement, velocity, rotation, and/or acceleration sensor(s).

Upon booting of IHS 100, processor(s) 101 may utilize Basic Input/Output System (BIOS) instructions of BIOS/Embedded Controller (EC) 109 to initialize and test hardware components coupled to IHS 100 and to load an OS for use by IHS 100. BIOS/EC 109 provides an abstraction layer that allows the OS to interface with certain hardware components that are utilized by IHS 100. Via the hardware abstraction layer provided by BIOS/EC 109, software stored in system memory 103 and executed by processor 101 can interface with certain I/O devices that are coupled to IHS 100. The Unified Extensible Firmware Interface (UEFI) was designed as a successor to BIOS. As a result, many modern IHSs utilize UEFI in addition to or instead of a BIOS. As used herein, BIOS/EC 109 is intended to also encompass a UEFI component.

BIOS/EC 109 may be installed as a Trusted Execution Environment (TEE) component to the motherboard of IHS 100. BIOS/EC 109 may implement operations for interfacing with a power adapter in managing power for IHS 100. Such operations may be utilized to determine the power status of IHS 100, such as whether IHS 100 is operating from battery power or is plugged into an AC power source. Firmware instructions utilized by BIOS/EC 109 may be used to provide various core operations of IHS 100, such as power management and management of certain modes of IHS 100 (e.g., turbo modes, maximum operating clock frequencies of certain components, etc.).

In some implementations, a low-power mode of operation may include the SO low-power idle model, also known as Modern Standby or Connected Standby, which provides an instant on/off user experience and maintains a network connection for certain processes while consuming very little power. These power modes may be entered, for example, when IHS 100 transitions into standby (e.g., “sleep,” etc.).

BIOS/EC 109 may also implement operations for detecting certain changes to the physical configuration or posture of IHS 100 and managing the modes of a touchpad or other user input device 106 in different configurations of IHS 100. For instance, where IHS 100 has a 2-in-1 laptop/tablet form factor, BIOS/EC 109 may receive inputs from a lid position or hinge angle sensor (e.g., one or more of HW sensors 110), and it may use those inputs to determine: whether the two sides of IHS 100 have been latched together to a closed position or a tablet position, the magnitude of a hinge or lid angle, etc.

BIOS/EC 109 may be further configured to calculate hashes or signatures that uniquely identify individual components of IHS 100. In such scenarios, BIOS/EC 109 may calculate a hash value based on the configuration of a hardware and/or software component coupled to IHS 100. For instance, BIOS/EC 109 may calculate a hash value based on all firmware and other code or settings stored in an onboard memory of a hardware component. Such hash values may be calculated as part of a trusted process of manufacturing IHS 100 and may be maintained in secure storage as a reference signature. BIOS/EC 109 may later recalculate the hash value for a component and compare it against the reference hash value to determine if any modifications have been made to the component, thus indicating that the component has been compromised. In this manner, BIOS/EC 109 may validate the integrity of hardware and software components installed on IHS 100.

In some embodiments, IHS 100 may not include all the components shown in FIG. 1. In other embodiments, IHS 100 may include other components in addition to those that are shown in FIG. 1. Furthermore, some components that are represented as separate components in FIG. 1 may instead be integrated with other components. For example, all or a portion of the operations executed by the illustrated components may instead be executed by components integrated into processor(s) 101 as systems-on-a-chip (SoC). As such, in various embodiments, IHS 100 may be implemented as different classes of computing devices including, but not limited to: servers, workstations, desktops, laptops, appliances, video game consoles, tablets, smartphones, etc.

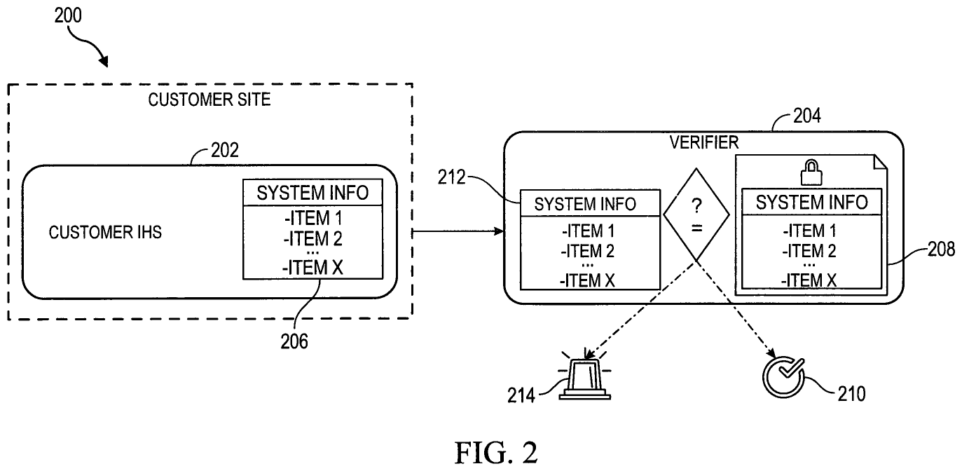

FIG. 2 illustrates an example system 200 according to one embodiment of the present disclosure. The system 200 generally includes a customer IHS 202 in communication with a verification server 204 managed by a vendor of the customer IHS 202. For example, the customer IHS 202 may be a laptop computer purchased or otherwise acquired from the vendor, while the verification server 204 may be an online vendor support portal managed by the vendor.

As described above with reference to FIG. 1, the customer IHS 202 may include a security processor 107 that includes a TPM to securely store encryption keys and measurements that help verify the integrity of IHS 100. The customer IHS 202 stores and publishes system information 206 about key components (e.g., BIOS, operating system, etc.) of the customer IHS 202. For example, the system information 206 may store cryptographic hash values associated with cryptographic hash functions for the key components of the customer IHS 202.

The customer IHS 202 may undergo numerous processing steps as it progresses to ownership by a customer. For example, the motherboard may be populated with one or more processors and memory units at one point in the chain, while being installed with an operating system at another point in the chain. Even after delivery to the customer, the customer IHS 202 may be taken to a third party repair site in which the repair sites represent one more points along the supply chain of the customer IHS 202.

It has been discovered by the inventors in the present case that a need exists for an external component to verify the integrity of the customer IHS 202 as it moves along its respective supply chain. According to embodiments of the present disclosure, the verification server 204 provides this external component. As such, the verification server 204 may be referred to as a verifier. The customer IHS 202 runs in the environment of the customer and is the subject of attestation. The customer IHS 202 should not be trusted since it may have been the subject of a supply chain cybersecurity attack.

The verification server 204 stores a golden copy 208 of the system information 206 used by the customer IHS 202. The golden copy 208 is to be used as a single source of truth or confidence, as it is generated by the platform, endorsed with a Certificate Authority (CA) of the vendor, and published during the manufacturing process before the customer IHS 202 is shipped to the customer, hence it may be considered to be trusted. In one embodiment, the golden copy 208, in the case of this CBSCV solution, may be the SCV certification that is compliant with the TCG Platform Certificate specifications. The state of the customer IHS 202 is considered trusted 210 or untampered with only when recently published system information 212 from the customer IHS 202 matches the golden copy 208 on the verification server 204. If a mismatch condition occurs, the platform would then be considered to be in a compromised or untrusted security state 214.

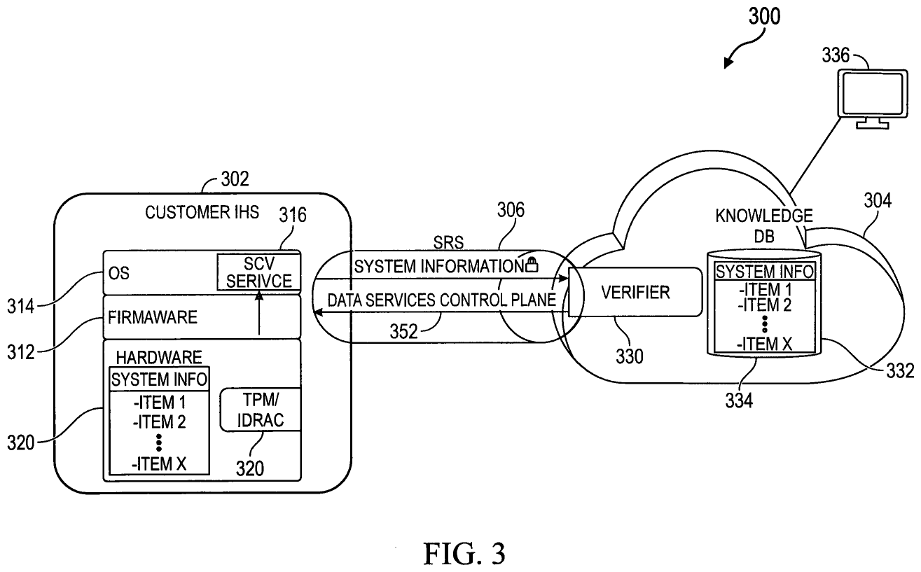

FIG. 3 illustrates several components of the system 300 according to one embodiment of the present disclosure. The components may include, for example, a customer IHS 302 in communication with a cloud-based verification service 304 via a transport layer 306. The customer IHS 302 includes a hardware layer 310 that supports a firmware layer 312 and an Operating System (OS) 314.

The OS 314 supports execution of a SCV Service 316. The SCV service 316 is a lightweight agent that collects the SCV information and publishes it to the cloud-based verification service 304. The SCV service 316 may be configured to shut down or restrict certain data services provided by the customer IHS 302 when it determines that the customer IHS 302 has been tampered with. It may be configured to be the last standing service relaying the state of the customer IHS 302 back to the cloud-based verification service 304. In one embodiment, the integrity of this service is guaranteed by the usage of the Linux Kernel's Integrity Measurement Architecture (IMA). The customer IHS 302 also includes a TPM configured on a Baseboard Management Controller (TPM/BMC) 320. The TPM/BMC 320 verifies the Proof of Possession by attesting to the cloud-based verification service 304.

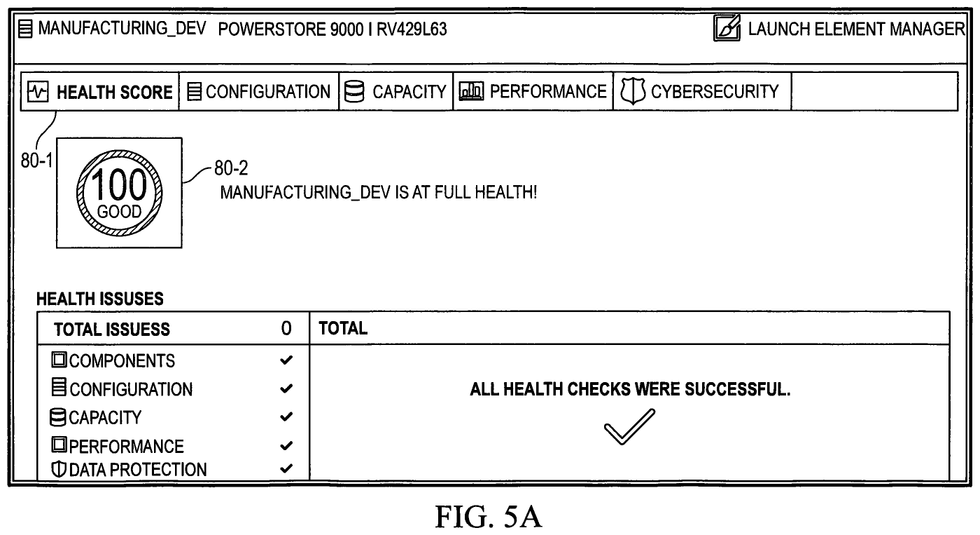

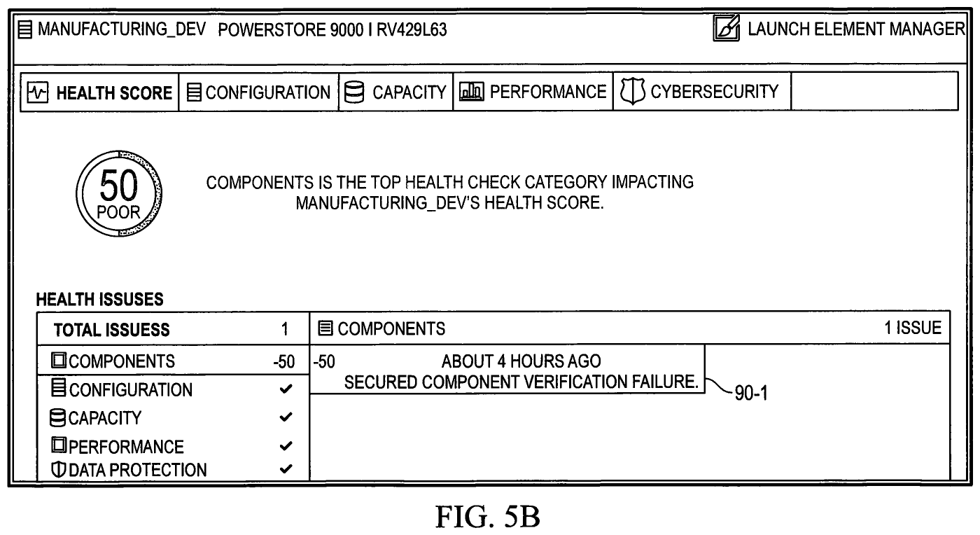

The cloud-based verification service 304 includes a verifier service 330 and is configured to verifying the integrity of the customer IHS 302. The cloud-based verification service 304 also includes a knowledge database 332 and a presentation layer 336. The knowledge database 332 stores a golden copy 334 of the system information for the customer IHS 302 in addition to a public version of an Endorsement Key (EK) that validates the signature of the signed SCV information. The presentation layer 336 is configured to degrade the health score of the customer IHS 302 to provide notification and alerting once the verifier service 330 has determined that the integrity of the customer IHS 302 has been compromised. For example, FIGS. 5A and 5B illustrate how the cloud-based verification service 304 indicates a healthy or degraded customer IHS 302 due to SCV attestation. In particular, FIG. 5A illustrates the customer IHS 302 being at a full health state, while FIG. 5B illustrates the customer IHS 302 being at a poor health state.

When a system is determined to be compromised, the verifier service 330 isolates the customer IHS 302 to reduce any potential damage (e.g., blast surface) to the customer IHS 302 and/or other interconnected systems. The verifier service 330 may isolate the customer IHS 302 by communicating one or more protective measures to the SCV Service 316. Examples of such protective measures may include, for example, stopping any replication of data to a secondary (e.g., ancillary) storage node, disconnecting any front end connectivity of the customer IHS 302, enabling a service mode that has limited access (e.g., service account access only), enabling a diagnostic service associated with the customer IHS 302, enabling a data collection service to log the root of the problem, shutting down a file system service (NAS) of the customer IHS 302, shutting down block storage service (SAN), protecting the management database, restricting management connectivity to only allowing essential tools (e.g., PowerStore).

The transport layer 306 provides for secure communication between the customer IHS 302 and cloud-based verification service 304. In one embodiment, the transport layer 306 uses an SRS or ESRS channel that provides an added layer of security. The added layer of security is provided from a client registration aspect required for SRS/ESRS enablement that goes above and beyond the additional https security and TLS encryption. The transport layer 306 includes an eastbound link 350 that conveys SCV data being published to the cloud-based verification service 304, and a westbound link 352 that includes a Data Services Control Plane that responds to any detected supply chain attacks.

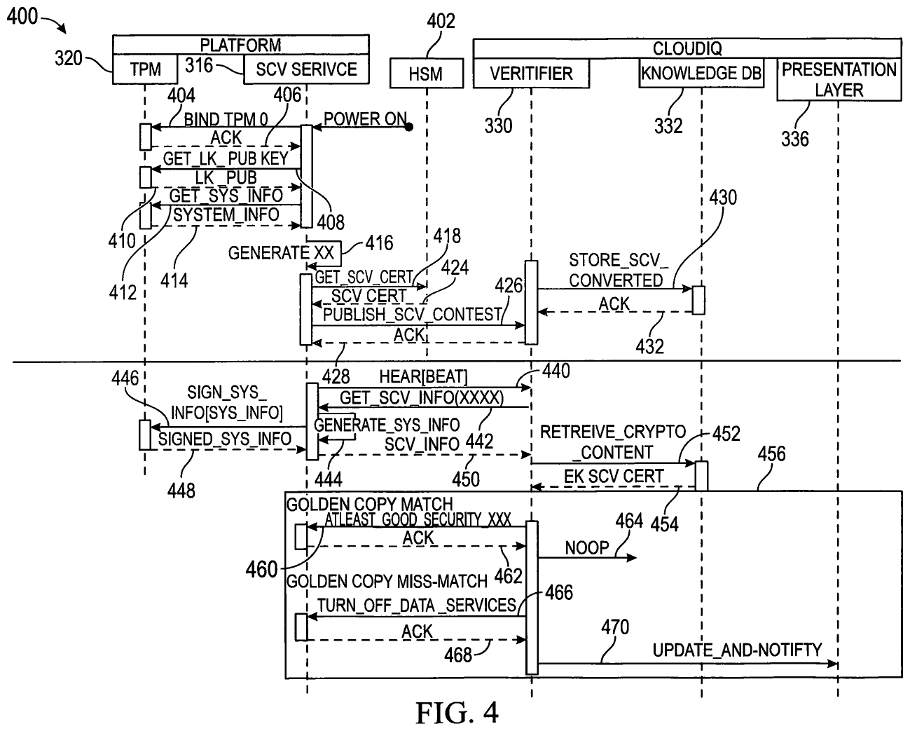

FIG. 4 illustrates an example workflow diagram showing a component verification method 400 according to one embodiment of the present disclosure. The component verification method may be performed, at least in part, by the various components of the component verification system 200 described herein above. In general, steps 404 through 432 may be performed after the customer IHS 302 has been assembled and configured with software and is ready to ship to the customer, while steps 440 through 470 generally describe steps that may be taken over the life of the customer IHS 302 to verify the authenticity of its components.

When the customer IHS is turned on at step 404, the SCV service 316 issues a bind request to the TPM 320, and receives an acknowledgment message at step 406. The SCV service 316 then requests an Endorsement Key (EK) at step 408 to the TPM 320, and receives a public EK at step 410. At step 412, the SCV service 316 requests system information from the TPM 320, and at step 414, receives the system information from the TPM 320.

At this point, the SCV service 316 generates a Certificate Signing Request (CSR) using the obtained system information and EK at step 416. Thereafter at step 418, the SCV service 316 issues a request to sign the CSR by a Hardware Security Module (HSM) 402, and receive the requested signed CSR at step 424. The SCV service 316 then publishes the signed CSR including the system information to the verifier service 330 at step 426, which is acknowledged at step 428. The verifier service 330 then sends the system information and associated EK to the knowledge database 332 at step 430, and receives an acknowledgment response at step 432.

Steps 440 through 470 generally describe steps that may be taken over the life of the customer IHS 302 to verify the authenticity of its components. The method may be performed at any time to verify that certain components (e.g., BIOS, OS, firmware, etc.) of the customer IHS has not been tampered with. As shown, the method 400 is performed at ongoing intervals (e.g., once an hour, once a day, once a week, etc.) in response to an ongoing heartbeat message. In other embodiments, the method 400 may be performed in response to a triggering event, such as installation of new software onto the customer IHS, updating of an existing software package, a change in hardware configuration, and the like.

At step 440, the SCV service 316 issues a heartbeat message to the verifier service 330 in which the verifier service 330 responds by issuing a request to obtain the system information at step 442. Thereafter at step 444, the SCV service 316 generates the system information, and at step 446 sends the system information to the TPM 320 to have it signed. At step 448, the TPM 320 sends the signed system information along with the EK to the SCV service 316, which is then forwarded to the verifier service 330 at step 450. At step 452, the verifier service 330 retrieves the golden copy of the system information from the knowledge database 332. For example, the golden copy may include that information that was stored in the knowledge database 332 earlier at step 430. Nevertheless, the verifier service 330 receives the requested golden copy at step 454.

The verifier service 330 compares the system information with the stored golden copy of the system information, determines whether the comparison matches, and generates control information based upon the comparison. If the comparison matches, the verifier service 330 sends a success message to the SCV service 316 at step 460, and receives an acknowledgment message at step 462. At step 470, the verifier service may communicate with the presentation layer 336 to generate a window indicating that the customer IHS 302 is at full health as shown in FIG. 5A. Because the verifier service 330 has determined that the system information was good, no further action is taken and the method 400 ends at step 464.

If, however, the comparison fails (the golden copy does not match the recently obtained system information), the verifier service 330 issues a failure message to the SCV service 316 at step 466, and receives an acknowledgment message at step 468. Because the comparison has failed, the SCV service 316 may perform one or more protective measure to remediate any potential problems that may exist with the customer IHS 302, such as those described hereinabove. The protective measures may be continually applied until the customer IHS 302 is updated to make the system information match that included in the golden copy stored in the knowledge database 332. At step 470, the verifier service may communicate with the presentation layer 336 to generate a window indicating that the customer IHS 302 possesses poor health as shown in FIG. 5B. At this point, no further action is taken and the method 400 ends.

Although FIG. 4 describes an example secured component verification process that may be performed to verify the authenticity of components of an IHS, the features of the process may be embodied in other specific forms without deviating from the spirit and scope of the present disclosure. For example, the process may perform additional, fewer, or different operations than those described in the present examples. For another example, the process may be performed in a sequence of steps different from that described above. For yet another example, the process may be performed by components other what is described hereinabove.

It should be understood that various operations described herein may be implemented in software executed by processing circuitry, hardware, or a combination thereof. The order in which each operation of a given method is performed may be changed, and various operations may be added, reordered, combined, omitted, modified, etc. It is intended that the invention(s) described herein embrace all such modifications and changes and, accordingly, the above description should be regarded in an illustrative rather than a restrictive sense.

The terms “tangible” and “non-transitory,” as used herein, are intended to describe a computer-readable storage medium (or “memory”) excluding propagating electromagnetic signals; but are not intended to otherwise limit the type of physical computer-readable storage device that is encompassed by the phrase computer- readable medium or memory. For instance, the terms “non-transitory computer readable medium” or “tangible memory” are intended to encompass types of storage devices that do not necessarily store information permanently, including, for example, RAM. Program instructions and data stored on a tangible computer-accessible storage medium in non-transitory form may afterward be transmitted by transmission media or signals such as electrical, electromagnetic, or digital signals, which may be conveyed via a communication medium such as a network and/or a wireless link.

Although the invention(s) is/are described herein with reference to specific embodiments, various modifications and changes can be made without departing from the scope of the present invention(s), as set forth in the claims below. Accordingly, the specification and figures are to be regarded in an illustrative rather than a restrictive sense, and all such modifications are intended to be included within the scope of the present invention(s). Any benefits, advantages, or solutions to problems that are described herein with regard to specific embodiments are not intended to be construed as a critical, required, or essential feature or element of any or all the claims.

Unless stated otherwise, terms such as “first” and “second” are used to arbitrarily distinguish between the elements such terms describe. Thus, these terms are not necessarily intended to indicate temporal or other prioritization of such elements. The terms “coupled” or “operably coupled” are defined as connected, although not necessarily directly, and not necessarily mechanically. The terms “a” and “an” are defined as one or more unless stated otherwise. The terms “comprise” (and any form of comprise, such as “comprises” and “comprising”), “have” (and any form of have, such as “has” and “having”), “include” (and any form of include, such as “includes” and “including”) and “contain” (and any form of contain, such as “contains” and “containing”) are open-ended linking verbs. As a result, a system, device, or apparatus that “comprises,” “has,” “includes” or “contains” one or more elements possesses those one or more elements but is not limited to possessing only those one or more elements. Similarly, a method or process that “comprises,” “has,” “includes” or “contains” one or more operations possesses those one or more operations but is not limited to possessing only those one or more operations.

1. An Information Handling System (IHS), comprising:
a host processor;
a security processor;
a memory coupled to the host processor, the memory having program instructions stored thereon that, upon execution by the host processor, cause the host processor to:
obtain system information associated with the IHS from the security processor;
sign the system information into a Secured Component Verification (SCV) certificate;
issue the SCV to a cloud-based verification server, wherein the verification server compares the system information with a stored golden copy of the system information, determines whether the comparison matches, and generates control information based upon the comparison;
receive the control information from the cloud-based verification server; and
control the operation of the IHS based on the control information.

2. The IHS of claim 1, wherein to generate the SCV, the program instructions, upon execution by the host processor, further cause the host processor to obtain an Endorsement Key (EK) from the security processor, wherein the verification server uses a public version of the EK to validate the signed system information.

3. The IHS of claim 1, wherein the program instructions, upon execution by the host processor, further cause the host processor to communicate with the verification processor using a secure communications link.

4. The IHS of claim 1, wherein the program instructions, upon execution by the host processor, further cause the host processor to perform one or more protective measures to control the operation of the IHS.

5. The IHS of claim 4, wherein the protective measure include at least one of stopping any replication of data to a secondary storage node, disconnecting any front end connectivity of the IHS, enabling a service mode that has limited access, enabling a diagnostic service associated with the IHS, enabling a data collection service, shutting down a file system service of the IHS, shutting down a block storage service, protecting a management database, and restricting management connectivity to one or more essential tools of the IHS.

6. The IHS of claim 1, wherein the program instructions, upon execution by the host processor, further cause the host processor to have the SCV signed by a Hardware Security Module (HSM).

7. The IHS of claim 1, wherein the program instructions, upon execution by the host processor, further cause the host processor to obtain the system information, generate and issue the SCV, receive the control information, and control the operation of the IHS at ongoing intervals.

8. The IHS of claim 1, wherein the security process is configured in a Baseboard Management Controller (BMC) of the IHS.

9. The IHS of claim 1, wherein the verification server is managed by a vendor of the IHS.

10. A method comprising:
obtaining system information associated with an Information Handling System (HIS) from a security processor;
signing the system information into a Secured Component Verification (Soy) certificate;
issuing the SCV to a cloud-based verification server, wherein the verification server compares the system information with a stored golden copy of the system information, determines whether the comparison matches, and generates control information based upon the comparison;
receiving the control information from the cloud-based verification server; and
controlling the operation of the IHS based on the control information.

11. The method of claim 10, further comprising obtaining, to generate the SCV, an Endorsement Key (EK) from the security processor, wherein the verification server uses a public version of the EK to validate the signed system information.

12. The method of claim 10, further comprising communicating with the verification processor using a secure communications link.

13. The method of claim 10, further comprising performing one or more protective measure to control the operation of the IHS.

14. The method of claim 10, further comprising having the SCV signed by a Hardware Security Module (HSM).

15. The method of claim 10, further comprising obtaining the system information, generating and issue the SCV, receiving the control information, and controlling the operation of the IHS at ongoing intervals.

16. A memory storage device having program instructions stored thereon that, upon execution by an Information Handling System (IHS), cause the IHS to:
obtain system information associated with the IHS from a security processor;
sign the system information into a Secured Component Verification (SCV) certificate;
issue the SCV to a cloud-based verification server, wherein the verification server compares the system information with a stored golden copy of the system information, determines whether the comparison matches, and generates control information based upon the comparison;
receive the control information from the cloud-based verification server; and
control the operation of the IHS based on the control information.

17. The memory storage device of claim 16, wherein to generate the SCV, the program instructions, upon execution by the IHS, further cause the host processor to obtain an Endorsement Key (EK) from the security processor, wherein the verification server uses a public version of the EK to validate the signed system information.

18. The memory storage device of claim 16, wherein the program instructions, upon execution by the IHS, further cause the host processor to perform one or more protective measures to control the operation of the IHS.

19. The memory storage device of claim 16, wherein the program instructions, upon execution by the IHS, further cause the host processor to obtain the system information, generate and issue the SCV, receive the control information, and control the operation of the IHS at ongoing intervals.

20. The memory storage device of claim 16, wherein the security process is configured in a Baseboard Management Controller (BMC) of the IHS.
